(19) United States
(12) Patent Application Publication
(10) Pub. No.: US 2021/0179863 A1
(43) Pub. Date: Jun. 17, 2021

(54) FOUL RELEASE COATING COMPOSITION, SUBSTRATE COATED WITH SUCH COATING COMPOSITION, AND USE OF SUCH COATING COMPOSITION

(71) Applicant: Akzo Nobel Coatings International B.V., Amhem (NL)

(72) Inventors: John David Sinclair-Day, Tyne & Wear (GB); Kevin John Reynolds, Tyne and Wear (GB); Cait Marie Cairns, Tyne & Wear (GB); Lindsay Hamilton, Durham (GB); Alison Louise Parry, Durham (GB); Graeme Dunford, Tyne & Wear (GB); Clayton Price, Tyne & Wear (GB)

(21) Appl. No.: 16/769,905

(22) PCT Filed: Jul. 13, 2018
(86) PCT No.: PCT/EP2018/069081

§ 371 Date: Jun. 4, 2020

(30) Foreign Application Priority Data
Dec. 14, 2017 (EP) 17207444.5

(51) Int. Cl. C09D 5/16; C09D 5/14; C08L 75/04; C08L 83/10; C08K 5/544; B05D 7/00

(52) U.S. Cl. CPC C09D 5/1675; C09D 5/1687; C09D 5/1693; C09D 5/14; C08L 75/04; B05D 2425/03; C08K 5/544; B05D 7/58; B05D 2425/01; B05D 2425/02; C08L 83/10

(57) ABSTRACT

The embodiments herein relate to a non-aqueous liquid foul release coating composition and process for controlling aqueous biofouling on man-made objects, including a curable resin system (A) comprising i) a curable polymer free of fluorine atoms and having a backbone selected from a polyurethane, a polyether, a polyester, a polycarbonate or a hybrid of two or more thereof, and having at least one terminal or pendant alkoxysilyl group and ii) optionally a curing agent and/or a catalyst; and (B) a marine biocide and/or a non-curable, non-volatile compound is selected from the group consisting of fluorinated polymers, sterols and sterol derivatives, and hydrophilic-modified polysiloxane oils, wherein the coating composition is essentially free of a curable polysiloxane, and wherein the coating composition is essentially free of non-curable polysiloxanes other than non-curable hydrophilic-modified polysiloxane oils.

### CROSS-REFERENCE TO RELATED APPLICATIONS

This application is a national stage application under 35 U.S.C. 371 of International Patent Application Serial No. PCT/EP2018/069081, filed Jul. 13, 2018, which claims benefit to EP Patent Application Serial No 17207444.5, filed Dec. 14, 2017, the disclosure of which is incorporated herein by reference.

### FIELD OF THE TECHNOLOGY

The embodiments herein relate to a non-aqueous liquid foul release coating composition for controlling aquatic biofouling on man-made objects, to a substrate coated with such coating composition, and to use of such coating composition to control aquatic biofouling on man-made objects.

### BACKGROUND

Man-made structures such as ship and boat hulls, buoys, drilling platforms, dry dock equipment, oil production rigs, aquaculture equipment and netting and pipes which are immersed in water, or have water running through them, are prone to fouling by aquatic organisms such as green and brown algae, barnacles, mussels, and the like. Such structures often are of metal, but may also be made of other structural materials such as concrete, glass re-enforced plastic or wood. Such fouling is a nuisance on ship and boat hulls, because it increases frictional resistance during movement through the water. As a consequence speed is reduced and fuel consumption increased. It is a nuisance on static structures such as the legs of drilling platforms and oil and gas production, refining and storage rigs, firstly because the resistance of thick layers of fouling to waves and currents can cause unpredictable and potentially dangerous stresses in the structure, and, secondly, because fouling makes it difficult to inspect the structure for defects such as stress cracking and corrosion. It is a nuisance in pipes such as cooling water intakes and outlets, because the effective cross-sectional area is reduced by fouling, with the consequence that flow rates are reduced.

It is known, that coatings with polysiloxane-based resins resist fouling by aquatic organisms. Such coatings are for example disclosed in GB 1307001 and U.S. Pat. No. 3,702,778. It is believed that such coatings present a surface to which the organisms cannot easily adhere, and they can accordingly be called fouling release or fouling resistant rather than anti-fouling coatings. Silicone rubbers and silicone compounds generally have very low toxicity.

In WO 2014/131695 is described an anti-fouling composition comprising a curable organosiloxane-containing polymer and a fluorinated oxyalkylene-containing polymer or oligomer.

Coating compositions based on curable polysiloxane resins are relatively soft at room temperature. In order to improve the mechanical properties of polysiloxane coatings, polysiloxane based coatings have been blended or crosslinked with stronger polymers such as epoxy resins or polyurethanes.

In WO 2012/146023 is disclosed a one-package moisture curable coating composition comprising 10-99 wt % silane terminated polyurethane and 1-90 wt % silane terminated polysiloxane. The polyurethane and the polysiloxane self-crosslink to form an organic-inorganic hybrid network. Microphase separation occurs at the surface and polysiloxane forms a surface structure with low surface energy that provides foul release properties.

In WO 2013/107827 is disclosed a coating composition, for use as a tie coat or a top coat in a foul release coating, comprising a curable polysiloxane and a silane terminated polyurethane. The curable polysiloxane and the silane terminated polyurethane are designed to co-cure.

Although very good in providing foul release properties, an important disadvantage of polysiloxane resins is that many other resins do not adhere to surfaces contaminated with polysiloxane resins. So, if a surface is contaminated with polysiloxane resin due to overspray or spilling of a polysiloxane-based coating, such surface has to be cleaned before a primer or other coating can be applied to it. Contamination of coating compositions based on non-polysiloxane based resins with a small amount of a polysiloxane-based composition, also has a negative impact on aesthetics of the coating. It typically causes pin hole and fish eye effects. Therefore, separate equipment for polysiloxane-based and non-polysiloxane-based coating has to be used. Even coating compositions containing a very small amount of polysiloxane resin give rise to contamination issues.

Therefore, there is a need in the art for foul release coating compositions that do not give rise to contamination issues whilst having good foul release and mechanical properties.

### SUMMARY

Surprisingly it has now been found that a non-aqueous foul release coating composition can be provided by using a resin system (A) comprising certain organic polymer backbones with terminal and/or pendant alkoxysilyl groups, and a marine biocide and/or a non-curable, non-volatile compound selected from the group consisting of fluorinated polymers, sterols and sterol derivatives, and hydrophilic-modified polysiloxane oils as a further fouling protection compound (B), wherein the coating composition is essentially free of curable polysiloxane resins and is essentially free of non-curable polysiloxanes other than non-curable hydrophilic-modified polysiloxane oils.

Accordingly, in a first aspect the embodiments herein provide a non-aqueous foul release coating composition for controlling aqueous biofouling on man-made objects, comprising:
(A) a curable resin system comprising
i) a curable polymer free of fluorine atoms and having a backbone selected from a polyurethane, a polyether, a polyester, a polycarbonate or a hybrid of two or more thereof, and having at least one terminal or pendant alkoxysilyl group of formula

—(CₘH₂ₘ)—Si(R¹)₍₃₋ₙ₎(OR²)ₙ (I)
wherein:
n is 1, 2 or 3, or n is 2 or 3;
each of R¹ and R² is, independently, an alkyl radical having 1 to 6 carbon atoms, or an alkyl radical having 1 to 4 carbon atoms;
m is an integer with a value in the range of from 1 to 20, and
ii) optionally a curing agent and/or a catalyst; and
(B) a marine biocide and/or a non-curable, non-volatile compound selected from the group consisting of fluorinated polymers, sterols and sterol derivatives, and hydrophilic-modified polysiloxane oils,
   wherein the coating composition is essentially free of a curable polysiloxane, and wherein the coating composition is essentially free of non-curable polysiloxanes other than non-curable hydrophilic-modified polysiloxane oils.

The coating composition according to the embodiments herein provides coatings with foul release properties that are similar to or even better than coating based on polysiloxane resins. The coating composition, moreover, provides coatings with ice-release properties. An important advantage of the coating composition according to the embodiments herein is that surfaces contaminated with small amounts of the coating composition can be coated with a primer or a topcoat without a negative impact on adhesion or aesthetics. A further advantage is that it provides coatings with improved mechanical properties, in particular abrasion resistance, compared to coatings based on polysiloxane resins.

In a second aspect, the embodiments herein provide a substrate coated with a foul release coating composition according to the first aspect. In some embodiments, the substrate is coated with a multi-layer coating system comprising a tie-coat layer deposited from a tie-coat composition comprising a binder polymer with alkoxysilyl functional groups and a topcoat layer deposited from the foul release coating composition according to the first aspect.

After the foul release coating composition has been applied to a substrate and dried, cured or crosslinked, the coated substrate can be immersed and gives protection against fouling. As indicated above, the foul release coating composition according to the embodiments herein provides coatings with very good fouling-resistant and foul release properties. This makes these coating compositions very suitable for coating objects that are immersed in an aquatic environment, such as marine and aquaculture applications. The coating can be used for both dynamic and static structures, such as ship and boat hulls, buoys, drilling platforms, oil production rigs, floating production storage and offloading vessels (FPSO), floating storage and regasification units (FSRU), cooling water intake in power plants, fish nets or fish cages and pipes which are immersed in water.

Accordingly, the embodiments herein provide in a third aspect a process for controlling aquatic biofouling on a surface of a man-made object, comprising the steps of
(a) applying a foul release coating composition according to the first aspect to at least a part of the surface of the man-made object;
(b) curing the foul release coating composition to form a cured foul release coating layer; and
(c) immersing the man-made object at least partly in water.

In a final aspect, the embodiments herein provide use of a foul release coating composition according to the first aspect to control aquatic biofouling on man-made objects.

In an embodiment, a non-aqueous liquid foul release coating composition for controlling aqueous biofouling on man-made objects is included, having (A) a curable resin system that can include i) a curable polymer free of fluorine atoms and having a backbone selected from a polyurethane, a polyether, a polyester, a polycarbonate or a hybrid of two or more thereof, and having at least one terminal or pendant alkoxysilyl group of formula (I): —(CₘH₂ₘ)—Si(R¹)₍₃₋ₙ₎(OR²)ₙ wherein: n is 1, 2 or 3, or 2 or 3, and each of R¹ and R² is, independently, an alkyl radical having 1 to 6 carbon atoms, or having 1 to 4 carbon atoms, m is an integer with a value in the range of from 1 to 20, and ii) optionally a curing agent and/or a catalyst, and (B) a marine biocide and/or a non-curable, non-volatile compound selected from the group consisting of fluorinated polymers, sterols and sterol derivatives, and hydrophilic-modified polysiloxane oils, wherein the coating composition is essentially free of a curable polysiloxane, and wherein the coating composition is essentially free of non-curable polysiloxanes other than non-curable hydrophilic-modified polysiloxane oils.

In an embodiment, a curable polymer (i) has at least one alkoxysilyl terminal group of formula (I), and in some embodiments at least two of said terminal groups.

In an embodiment, the at least one terminal or pendant alkoxysilyl group is attached to the backbone of the curable polymer (i) via a urethane or a urea linkage.

In an embodiment, a foul release coating composition is provided where m is 1 or 3, or m is 1.

In an embodiment, a foul release coating composition is provided where R² is a methyl or ethyl radical.

In an embodiment, a foul release coating composition is provided where the curable resin system includes a curing agent selected from the group consisting of tetra-alkoxyorthosilicates and partial condensates thereof; organofunctional alkoxysilanes, and combinations thereof, wherein in some embodiments, the curing agent is a tetra-alkoxyorthosilicate or a partial condensate thereof, an organofunctional alkoxysilane selected from the group consisting of amino alkoxysilanes, glycidoxy alkoxysilanes, methacryloxy alkoxysilanes, carbamato alkoxysilanes; and alkoxysilanes with an isocyanurate functional group, or a combination thereof.

In an embodiment, the curing agent is an organofunctional alkoxysilane with the alkoxysilyl functionality in an alpha position to the organofunctional group, and in some embodiments the curing agent is (N,N-diethylaminomethyl)triethoxysilane, and the coating composition is essentially free of a curing catalyst.

In an embodiment, a foul release coating composition where the coating composition is free of a marine biocide.

In an embodiment, a foul release coating composition where the coating composition includes a non-curable, non-volatile compound selected from the group consisting of hydrophilic-modified polysiloxane oils.

In an embodiment, the non-curable, non-volatile hydrophilic-modified polysiloxane oil is a poly(oxyalkylene)-modified polysiloxane.

In an embodiment, a substrate coated with a foul release coating composition is provided.

In an embodiment, the substrate is coated with a multi-layer coating system and can include: optionally a primer layer applied to the substrate and deposited from a primer coating composition; a tie-coat layer applied to the substrate or to the optional primer layer, deposited from a tie-coat composition can include a binder polymer with curable alkoxysilyl functional groups; and a topcoat layer applied to the tie-coat layer, the topcoat layer deposited from a liquid foul release coating composition

In an embodiment, the tie-coat composition includes a polyacrylate with curable alkoxysilyl functional groups.

In an embodiment, a process for controlling aquatic biofouling on a surface of a man-made object is provided an can include the steps of (a) applying a foul release coating composition, (b) allowing the foul release coating composition to cure to form a cured foul release coating layer, and (c) immersing the man-made object at least partly in water.

In an embodiment, a process further can include the step of applying a tie-coat layer deposited from a tie-coat composition on the at least part of the surface of the man-made object before applying the foul release coating composition.

### DETAILED DESCRIPTION

The foul release coating composition according to the embodiments herein is a non-aqueous liquid coating composition. It comprises a curable resin system (A) comprising i) a curable polymer and ii) optionally a curing agent (crosslinking agent) and/or a curing catalyst. To provide enhanced protection against fouling, the coating composition further comprises a marine biocide and/or a non-curable, non-volatile compound selected from the group consisting of fluorinated polymers, sterols and sterol derivatives, and hydrophilic-modified polysiloxane oils as component (B). The foul release coating composition may further comprise organic solvent, pigments, and one of more additives commonly used in non-aqueous liquid coating compositions. The coating composition system is essentially free of a curable polysiloxane and is essentially free of non-curable polysiloxanes other than non-curable hydrophilic-modified polysiloxane oils.

Reference herein to a curable polysiloxane is to a polymer with a backbone having Si—O—Si linkages, with at least some of the silicon atoms attached to a carbon atom, and having pendant and/or terminal cross-linkable functional groups. Reference herein to cross-linkable functional groups is to groups that can self-condense or condense with a cross-linking agent to form covalent cross-links when applied under normal conditions, typically at a temperature between −10° C. and 50° C., such as for example pendant or terminal silanol, alkoxysilyl, acetoxysilyl or oximesilyl groups.

Reference herein to pendant groups is to lateral, i.e. non-terminal, groups.

Reference herein to ‘essentially free of a compound’ is to a composition comprising less than 0.5 wt %, or less than 0.1 wt % of such compound, or a composition entirely free of such compound.

The foul release coating composition of the embodiments herein is a liquid coating composition. This means that the composition is liquid at ambient temperature and can be applied at ambient conditions to a substrate by well-known application techniques for liquids, such as brushing, rolling, dipping, bar application or spraying.

The coating composition is a non-aqueous coating composition. This means that the components of the resin system and other ingredients of the coating composition are provided, e.g. dissolved or dispersed, in a non-aqueous liquid medium. The coating composition may comprise an organic solvent to achieve the required application viscosity. Alternatively, the coating composition may be free of organic solvent, for example when the curable polymer, optionally after addition of a reactive diluent and/or liquid plasticizer, is a liquid of sufficiently low viscosity. The coating composition may comprise a small amount of water, for example water unintentionally introduced with other components of the coating composition, such as pigments or organic solvents, which contain low amounts of water as impurity. The coating composition can include less than 5 wt % of water, or less than 2 wt %, based on the total weight of the composition. In some embodiments, the composition is free of water.

The curable polymer (i) has a backbone that is a polyurethane, a polyether, polyester, a polycarbonate, or a hybrid of two or more thereof. Reference herein to a polyurethane backbone is to a backbone with urethane linkages. Such backbone is formed by reacting a mixture of polyol and polyisocyanates. In some embodiments, the backbone is formed by reacting a mixture with di-isocyanate. Any suitable polyol or polyisocyanate may be used. Suitable polyols for examples include polyester polyol, polyether polyol, polyoxyalkylene polyols, acrylic polyol, polybutadiene polyol, natural oil derived polyols. In case the polyol is a polyether polyol, the polymer backbone has both urethane and ether linkages and is referred to herein as a polyether/polyurethane hybrid. In case the polyol is a polyester polyol, the polymer backbone has both urethane and ester linkages and is referred to herein as a polyester/polyurethane hybrid. In various embodiments, the curable polymer (i) has a backbone that is a polyurethane, a polyether, or a polyether/polyurethane hybrid.

The curable polymer (i) has at least one alkoxysilyl terminal or pendant group of formula (I):

—(CₘH₂ₘ)—Si(R¹)₍₃₋ₙ₎(OR²)ₙ (I)

wherein:
n is 1, 2 or 3, or n is 2 or 3;
each of R¹ and R² is, independently, an alkyl radical having 1 to 6 carbon atoms, or an alkyl radical having 1 to 4 carbon atoms;
m is an integer with a value in the range of from 1 to 20.

Bivalent saturated hydrocarbon radical CₘH₂ₘ is linking alkoxysilyl group —Si(R¹)₍₃₋ₙ₎(OR²)ₙ to the backbone of curable polymer i), or in some embodiments via a urethane or urea linkage. In various embodiments, m is an integer with a value in the range of from 1 to 6. In other embodiments, m is 1 or 3. If m is 1, the curable alkoxysilyl group(s) are in the alpha position to the urethane or urea linkage. Such alpha position provides higher reactivity of the alkoxysilyl group(s) and therewith higher curing rates.

The alkoxysilyl terminal or pendant group may have one, two or three alkoxy groups OR², or two or three alkoxy groups (n is 2 or 3). The alkoxy groups OR² can include methoxy or ethoxy groups (R² being a methyl or ethyl radical). In case of one or two alkoxy groups, two or one alkyl radicals R¹ are attached to the silicon atom, respectively. R¹ is an alkyl radical having 1 to 20 carbon atoms, or an alkyl radical having 1 to 6 carbon atoms. In some embodiments, R¹ is a methyl or ethyl radical.

In various embodiments, curable polymer (i) has at least one terminal alkoxysilyl group of formula (I), or at least two terminal alkoxysilyl groups of formula (I).

Curable polymer (i) is free of fluorine atoms and may be linear or branched. In various embodiments, curable polymer (i) is essentially linear and has two terminal alkoxysilyl groups of formula (I). The curable polymer (i) may have pendant and terminal alkoxysilyl groups of formula (I).

Curable polymers with an organic polymer backbone and alkoxysilyl groups of formula (I) are known in the art and for example described in U.S. Pat. No. 5,990,257. Such polymers may for example be prepared by reacting an isocyanate functionalized alkoxysilane with a hydroxyl-terminated prepolymer such as a polyether polyol, a polyurethane polyol or a polyether-polyurethane hybrid polyol or by reacting an amino alkoxysilane with an isocyanate terminated prepolymer, such as an isocyanate terminated polyurethane or polyether-polyurethane hybrid. Commercially available examples of such curable polymers include GENIOSIL® STP-E (ex. Wacker), Desmoseal S XP 2636, Desmoseal S XP 2749 (ex. Covestro), TEGOPAC SEAL 100, Polymer ST 61 LV and Polymer ST 80 (ex. Evonik).

The resin system may comprise a further curable polymer other than curable polymer (i). If such further curable polymer is present, the further curable polymer can include a curable polymer comprising pendant and/or terminal alkoxysilyl functional groups, for example a poly(meth)acrylate comprising pendant alkoxysilyl groups. Such further curable polymer comprising pendant and/or terminal alkoxysilyl functional groups may be present in an amount up to 80 wt %, or up to 70 wt %, or in the range of from 10 to 60 wt %, based on the total weight of curable polymer (i) and any further curable polymer with alkoxysilyl functional groups.

The coating composition may comprise a further curable polymer without alkoxysilyl functional groups. Such further curable polymer without alkoxysilyl functional groups can be present in an amount less than 50 wt % based on the total weight of curable polymer (i) and any further curable polymer with alkoxysilyl functional groups, or can be present in an amount less than 30 wt %, or can be present in an amount less than 10 wt %. In various embodiments, the resin system is essentially free of or entirely free of curable polymers without alkoxysilyl functional groups. The coating composition is essentially free of a curable polysiloxane.

The curable resin system can include a curing agent or a curing catalyst. The resin system may comprise both a curing agent and a curing catalyst.

The curing agent (also referred to as cross-linking agent) may be any curing agent suitable for crosslinking the terminal or pendant alkoxysilyl groups of curable polymer (i). Such curing agents are known in the art. Functional silanes are known as suitable curing agents. Exemplary curing agents include tetra-alkoxy orthosilicates (also referred to as tetra-alkoxysilanes), such as for example tetra-ethylorthosilicate or partial condensates thereof, and organofunctional alkoxysilanes, such as amino alkoxysilanes, glycidoxy alkoxysilanes, methacryloxy alkoxysilanes, carbamato alkoxysilanes, and alkoxysilanes with an isocyanurate functional group. Additional examples of exemplary curing agents suitable for use herein are tetra-ethylorthosilicate or partial condensates thereof, N-[3-(trimethoxysilyl)propyl]ethylenediamine, and (N,N-diethylaminomethyl) triethoxysilane.

The curing agent may be used in any suitable amount, typically up to 10 wt % based on the total weight of the resin system (weight of curable polymer plus curing agent plus optional catalyst), or in the range of from 1 to 5 wt %.

In case an organofunctional alkoxysilane with the alkoxysilyl functionality in an alpha position to the organofunctional group is used as curing agent, the coating composition may be cured under ambient conditions in the absence of a curing catalyst. Suitable organofunctional alkoxysilanes with the alkoxysilyl functionality in an alpha position to the organofunctional group include alpha aminosilanes. In various embodiments, the alpha aminosilane is (N,N-diethylaminomethyl)triethoxysilane.

Instead of a curing agent, or in addition to a curing agent, the resin system may comprise a curing catalyst. Any catalyst suitable for catalyzing the condensation reaction between silanol groups may be used. Such catalysts are well known in the art and include carboxylic acid salts of various metals, such as tin, zinc, iron, lead, barium, and zirconium. Such salts include salts of long-chain carboxylic acids, for example dibutyltin dilaurate, dioctyltin dilaurate, dibutyltin dioctoate, iron stearate, tin (II) octoate, and lead octoate. Further examples of suitable catalysts include organobismuth, organotitanium compounds, organo-phosphates such as bis(2-ethylhexyl) hydrogen phosphate. Other possible catalysts include chelates, for example dibutyltin acetoacetonate, or compound comprising amine-ligands such as for example 1,8-diazabicyclo(5.4.0)undec-7-ene. The catalyst may comprise a halogenated organic acid which has at least one halogen substituent on a carbon atom which is in the [alpha]-position relative to the acid group and/or at least one halogen substituent on a carbon atom which is in the beta position relative to the acid group, or a derivative which is hydrolysable to form such an acid under the conditions of the condensation reaction. Alternatively, the catalyst may be as described in any of WO 2007/122325, WO 2008/055985, WO 2009/106717, WO 2009/106718.

The catalyst may be used in any suitable amount, including in the range of from 0.1 to 10 wt % based on the total weight of the resin system (weight of curable polymer plus optional curing agent plus catalyst), and in the range of from 0.2 to 1.0 wt %.

If the curable resin system comprises a curing catalyst, the coating composition can be a two-component (2K) coating composition wherein the curing catalyst and the curable polymer of the curable resin system are provided in different components that are mixed shortly before application of the coating composition.

To provide enhanced protection against fouling, the coating composition comprises a marine biocide and/or a non-curable, non-volatile compound (an incompatible fluid). Reference herein to a non-curable compound is to a compound that does not participate in the curing reaction of curable polymer (i) or any further curing polymer in the resin system. Reference herein to non-volatile compounds is to compounds that do not boil at a temperature below 250° C., at atmospheric pressure.

The non-curable, non-volatile compound is selected from the group consisting of fluorinated polymers, sterols and sterol derivatives, such as for example lanolin, lanolin oil, or acetylated lanolin, and hydrophilic-modified polysiloxane oils, such as poly(oxyalkylene)-modified polysiloxane oils.

Examples of suitable fluorinated polymers include linear and branched trifluoromethyl fluorine end-capped perfluoropolyethers (e.g. Fomblin Y®, Krytox K® fluids, or Demnum S® oils); linear di-organo (OH) end-capped perfluoropolyethers (eg Fomblin Z DOL®, Fluorolink E®); low molecular weight polychlorotrifluoroethylenes (eg Daifloil CTFE® fluids); and fluorinated oxyalkylene-containing polymer or oligomer as described in WO 2014/131695. Non-curable hydrophilic-modified polysiloxane oils are known in the art and for examples described at pages 22 to 26 of WO 2013/000479, incorporated herein by reference for the description of such non-curable hydrophilic-modified polysiloxane oils. Such non-curable hydrophilic-modified polysiloxane oils do not comprise any terminal or lateral silanol, alkoxysilyl, or other silicon-reactive groups.

The coating composition can include a non-curable, non-volatile compound as defined herein above. In some embodiments, the coating composition comprises a non-curable, non-volatile compound selected from the group consisting of hydrophilic-modified polysiloxane oils, and in other embodiments selected from the group consisting of poly(oxyalkylene)-modified polysiloxane oils. Such poly(oxyalkylene)-modified polysiloxane oil may have pendant and/terminal poly(oxyalkylene) groups and/or may have a polyoxyalkylene chain incorporated in its backbone. In various embodiments, the poly(oxyalkylene)-modified polysiloxane oil has pendant poly(oxyalkylene) groups.

The poly(oxyalkylene)-modified polysiloxane oil can include oxyalkylene moieties with 1 to 20 carbon atoms, or with 2 to 6 carbon atoms, and in other embodiments can include those with oxyethylene and/or oxypropylene moieties. The pendant, terminal or block co-polymerized poly(oxyalkylene) groups can include 1 to 50 oxyalkylene moieties, or 2 to 20 oxyalkylene moieties. The polysiloxane oil may comprise in the range of from 1 to 100 pendant/terminal poly(oxyalkylene) groups and/or 1 to 100 copolymerized poly(oxyalkylene) blocks; and in some embodiments in the range of from 1 to 50; or in other embodiments from 2 to 20. A particularly suitable hydrophilic-modified polysiloxane oil is a polydimethylsiloxane comprising pendant poly(oxyethylene) groups and comprising pendant alkyl groups other than methyl groups.

The pendant or terminal oxyalkylene moieties can be linked to a silicon atom of the polysiloxane backbone via a divalent hydrocarbon group, or a divalent hydrocarbon group having 1 to 8 carbon atoms, or three carbon atoms. The pendant or terminal poly(oxyalkylene) groups may be capped with any suitable group, including a hydroxyl, ether, or ester group, or a hydroxyl group or an ether or ester group with two to 6 carbon atoms, such as for example an acetate group.

Commercially available examples of suitable hydrophilic-modified polysiloxane include DC5103, DC Q2-5097, DC193, DC Q4-3669, DC Q4-3667, DC-57 and DC2-8692 (all Dow Corning), Silube J208 (Siltech), and BYK333 (BYK). A non-curable, non-volatile compound may be added in any suitable amount, typically up to 20 wt % based on the total weight of the coating composition, or in the range of from 1 to 10 wt %, or from 2 to 7 wt %.

Reference herein to a marine biocide is to a chemical substance known to have chemical or biological biocidal activity against marine or freshwater organisms. Suitable marine biocides are well-known in the art and include inorganic, organometallic, metal-organic or organic biocides. Examples of inorganic biocides include copper compounds such as copper oxide, copper thiocyanate, copper bronze, copper carbonate, copper chloride, copper nickel alloys, and silver salts such as silver chloride or nitrate; organometallic and metal-organic biocides include zinc pyrithione (the zinc salt of 2-pyridinethiol-1-oxide), copper pyrithione, bis (N-cyclohexyl-diazenium dioxy) copper, zinc ethylene-bis(dithiocarbamate) (i.e. zineb), zinc dimethyl dithiocarbamate (ziram), and manganese ethylene-bis(dithiocarbamate) complexed with zinc salt (i.e. mancozeb); and organic biocides include formaldehyde, dodecylguanidine monohydrochloride, thiabendazole, N-trihalomethyl thiophthalimides, trihalomethyl thiosulphamides, N-aryl maleimides such as N-(2,4,6-trichlorophenyl) maleimide, 3-(3,4-dichlorophenyl)-1,1-dimethylurea (diuron), 2,3,5,6-tetrachloro-4-(methylsulphonyl) pyridine, 2-methylthio-4-butylamino-6-cyclopopylamino-s-triazine, 3-benzo[b]thien-yl-5,6-dihydro-1,4,2-oxathiazine 4-oxide, 4,5-dichloro-2-(n-octyl)-3(2H)-isothiazolone, 2,4,5,6-tetrachloroisophthalonitrile, tolylfluanid, dichlofluanid, diiodomethyl-p-tosylsulphone, capsciacin or a substituted capsciacin, N-cyclopropyl-N′-(1,1-dimethylethyl)-6-(methylthio)-1,3,5-triazine-2,4-diamine, 3-iodo-2-propynylbutyl carbamate, medetomidine, 1,4-dithiaanthraquinone-2,3-dicarbonitrile (dithianon), boranes such as pyridine triphenylborane, a 2-trihalogenomethyl-3-halogeno-4-cyano pyrrole derivative substituted in position 5 and optionally in position 1, such as 2-(p-chlorophenyl)-3-cyano-4-bromo-5-trifluoromethyl pyrrole (tralopyril), and a furanone, such as 3-butyl-5-(dibromomethylidene)-2(5H)-furanone, and mixtures thereof, macrocyclic lactones such as avermectins, for example avermectin B1, ivermectin, doramectin, abamectin, amamectin and selamectin, and quaternary ammonium salts such as didecyldimethylammonium chloride and an alkyldimethylbenzylammonium chloride.

Optionally, the biocide is wholly or partially encapsulated, adsorbed, entrapped, supported or bound. Certain biocides are difficult or hazardous to handle and are advantageously used in an encapsulated, entrapped, absorbed, supported, or bound form. Encapsulation, entrapment, absorption, support or binding of the biocide can provide a secondary mechanism for controlling biocide leaching from the coating system in order to achieve an even more gradual release and long lasting effect. The method of encapsulation, entrapment, adsorption, support or binding of the biocide is not particularly limiting for the embodiments herein. Examples of ways in which an encapsulated biocide may be prepared for use herein include mono and dual walled amino-formaldehyde or hydrolysed polyvinyl acetate-phenolic resin capsules or microcapsules as described in EP 1 791 424. An example of a suitable encapsulated biocide is encapsulated 4,5-dichloro-2-(n-octyl)-3(2H)-isothiazolone marketed by Dow Microbial Control as Sea-Nine 211 N R397 Marine Antifouling Agent. Examples of ways in which an absorbed or supported or bound biocide may be prepared include the use of host-guest complexes such as clathrates as described in EP 709 358, phenolic resins as described in EP 880 892, carbon-based adsorbents such as those described in EP 1 142 477, or inorganic microporous carriers such as the amorphous silicas, amorphous aluminas, pseudoboehmites or zeolites described in EP 1 115 282.

In view of environmental and health concerns linked to the use of biocides in coatings for the prevention of aquatic biofouling, component (B) in the coating compositions according to the embodiments herein are not a marine biocide.

Therefore, some embodiments, the coating composition is essentially or entirely free of a marine biocide and enhanced protection against fouling is provided by a non-biocidal component, said non-biocidal component being a non-curable, non-volatile compound selected from the group consisting of fluorinated polymers, sterols and sterol derivatives, and hydrophilic-modified polysiloxane oils.

Suitable solvents for use in the coating composition include aromatic hydrocarbons, alcohols, ketones, esters, and mixtures of the above with one another or an aliphatic hydrocarbon. Exemplary solvents include ketones such as methyl isopentyl ketone and/or hydrocarbon solvents, such as xylene, trimethyl benzene, or aliphatic cyclic or acyclic hydrocarbons, as well as mixture thereof.

The foul release coating composition may further comprise extender pigments (fillers) and/or color pigments and one or more additives commonly used in foul release coating compositions, such as wetting agents, dispersing agents, flow additives, rheology control agents, adhesion promoters, antioxidants, UV stabilizers, and plasticizers.

Examples of suitable extender pigments include barium sulphate, calcium sulphate, calcium carbonate, silicas or silicates (such as talc, feldspar, and china clay), including pyrogenic silica, bentonite and other clays. Some extender pigments, such as fumed silica, may have a thixotropic effect on the coating composition. The proportion of fillers may be in the range of from 0 to 25 wt %, based on the total weight of the coating composition. In some embodiments, clay is present in an amount of 0 to 1 wt % and the thixotrope can be present in an amount of 0 to 5 wt %, based on the total weight of the coating composition.

Examples of color pigments include black iron oxide, red iron oxide, yellow iron oxide, titanium dioxide, zinc oxide, carbon black, graphite, red molybdate, yellow molybdate, zinc sulfide, antimony oxide, sodium aluminium sulfosilicates, quinacridones, phthalocyanine blue, phthalocyanine green, indanthrone blue, cobalt aluminium oxide, carbazoledioxazine, chromium oxide, isoindoline orange, bis-acetoaceto-tolidiole, benzimidazolone, quinaphthalone yellow, isoindoline yellow, tetrachloroisoindolinone, and quinophthalone yellow, metallic flake materials (e.g. aluminium flakes).

The composition may also comprises so-called barrier pigments or anticorrosive pigments such as zinc dust or zinc alloys, or so-called lubricious pigments such as graphite, molybdenum disulfide, tungsten disulphide or boron nitride.

The pigment volume concentration of the coating composition can be in the range of 0.5-25%. The total amount of pigments may be in the range of from 0 to 25 weight %, based on the total weight of the coating composition.

The coating composition can have a non-volatile content, defined as the weight percentage of non-volatile material in the coating composition, of at least 35 weight %, or at least 50 weight %, or at least 70 weight %. The non-volatile content can range up to 80 weight %, 90 weight %, 95 weight % and up to 100 weight %. The non-volatile content may be determined in accordance with ASTM method D2697.

The embodiments herein further relate to a substrate coated with a foul release coating composition according to the first aspect. The foul release coating composition can be applied by known techniques for applying liquid coating compositions, such as brush, roller, dipping, bar or spray (airless and conventional) application.

The substrate may be a surface of a structure to be immersed in water, such as metal, concrete, wood, or polymeric substrates. Examples of polymeric substrates are polyvinyl chloride substrates or composites of fiber-reinforced resins. In an alternative embodiment, the substrate is a surface of a flexible polymeric carrier foil. The coating composition is then applied to one surface of a flexible polymeric carrier foil, for example a polyvinyl chloride carrier foil, and cured, and subsequently the non-coated surface of the carrier foil is laminated to a surface of a structure to be provided with fouling-resistant and/or foul release properties, for example by use of an adhesive.

To achieve good adhesion to the substrate the fouling-release coating composition can be applied to a substrate that is provided with a primer layer and/or a tie-coat layer. The primer layer may be deposited from any primer composition known in the art, for example an epoxy resin-based or polyurethane based primer composition. In some embodiments, the substrate is provided with a tie-coat layer deposited from a tie-coat composition, before applying a foul release coating layer deposited from the fouling-release coating composition. The tie-coat composition may be applied to the bare substrate surface, to a primed substrate surface or to a substrate surface containing an existing layer of anti-fouling or foul release coating composition.

Tie-coat compositions are known in the art. In various embodiments, the tie-coat layer is deposited from a tie-coat composition comprising a binder polymer with alkoxysilyl functional groups capable of reacting with the pendant or terminal alkoxysilyl group(s) of curable polymer (i). Such tie-coat compositions are known in the art and for example described in WO 99/33927.

The binder polymer with curable alkoxysilyl functional groups in the tie-coat composition may be any suitable binder polymer, for example polyurethane, polyurea, polyester, polyether, polyepoxy, or a binder polymer derived from ethylenically unsaturated monomers such as a polyacrylate. In some embodiments, the binder polymer is a polyacrylate with curable alkoxysilyl functional groups. Reference herein to polyacrylate is to a polymer obtainable by radical polymerisation of acrylate and/or (meth)acrylate monomers.

The alkoxysilyl functional groups can include the following general formula:

—(CₘH₂ₘ)—Si(R¹)₍₃₋ₙ₎(OR²)ₙ

wherein n, R¹, R² and m are as defined herein above for formula (I). In some embodiments, n is 2 or 3. Each of R¹ and R² is, independently, can include an alkyl radical having 1 to 4 carbon atoms, or an ethyl or a methyl. In some embodiments, m is an integer with a value in the range of from 1 to 6. In other embodiments, m is 1 or 3. In yet other embodiments, m is 1.

In some embodiments, the binder polymer in the tie-coat composition is prepared by radical polymerisation of a mixture of acrylate and/or (meth)acrylate monomers of which at least one has alkoxysilyl functionality, such as for example 3-(trimethoxysilylpropyl) methacrylate or trimethoxysilylmethyl methacrylate. An example of such monomer mixture is a mixture of methyl methacrylate, lauryl methacrylate and trimethoxysilylmethyl methacrylate.

In some embodiments, the binder polymer in the tie-coat composition does not have crosslinkable functional groups other than the alkoxysilyl functional groups.

### Examples

The embodiments herein will be further illustrated by means of the following non-limiting examples.

The following compounds were used in the examples.

### Curing Agents

Gamma-aminosilane: N-[3-(trimethoxysilyl)propyl]ethylenediamine

Alpha-aminosilane: (N,N-diethylaminomethyl)triethoxysilane Tetraethylorthosilicate (TEOS)

### Curing Catalysts

DBU: 1,8-diazabicyclo(5.4.0)undec-7-ene

Zinc catalyst: K-KAT® 670 (ex. King Industries)

Acid catalyst: bis(2-ethylhexyl) hydrogen phosphate

### Curable Polymers

See Table 1.

### Example 1—Curing of Different Polymers with Silane Functional Groups

The curability of different, commercially available curable polymers with terminal or pendant alkoxysilyl functional groups was determined by mixing such polymers with different amounts of gamma-aminosilane or alpha-aminosilane as curing agent, or with 0.5 wt % of a curing catalyst. A 200 μm draw down of the mixture was applied on a glass panel, and the applied layer was allowed to cure at ambient conditions (23° C., 50% relative humidity).

The time to hard dry was determined. Hard dry means that no visible marks are made when the coating is firmly touched with a finger and the finger is rotated 180°. After 24 hours or 1 week, the test was stopped and the drying state (wet, tacky, touch dry or hard dry) was determined.

The results are shown in Tables 2 and 3.

TABLE 1
Curable polymers used

| Polymer name | backbone | Alkoxysilyl group | |
|---|---|---|---|
| GENIOSIL ® | polyether | dimethoxy(methyl)silyl | terminal |
| STP-E10 | | methylcarbamate | |
| GENIOSIL ® | polyether | trimethoxysilyl | terminal |
| STP-E15 | | propylcarbamate | |
| GENIOSIL ® | polyether | dimethoxy(methyl)silyl | terminal |
| STP-E30 | | methylcarbamate | |
| GENIOSIL ® | polyether | trimethoxysilyl | terminal |
| STP-E35 | | propylcarbamate | |
| Desmoseal | polyurethane | trialkoxysilylpropyl | terminal |
| S XP 2749 | | | |
| Polymer ST | urethane/ | trimethoxysilyl | terminal |
| 61LV | polyether | | |
| | hybrid | | |
| TEGOPAC SEAL | polyether | triethoxysilyl | pendant |
| 100 | | | |

TABLE 2
Cure times until hard dry for different polymers with
alpha aminosilane as curing agent or curing catalyst

| | Alpha amino silane (wt % on wet | | | | | |
|---|---|---|---|---|---|---|
| | weight) | | | Catalyst (0.5 wt %) | | |
| Polymer | 1.0 wt % | 5.0 wt % | 10 wt % | DBU | acid | zinc |
| STP-E | <24 h | 3 h | 3 h | 5 min | 1 h | 1 h |
| 10 | | | | | | |
| STP-E | 1 week: | <24 h | <24 h | 15 min | 5 h | 7 h |
| 15 | tacky | | | | | |
| S XP | <24 h | <24 h | <24 h | 30 min | 5 h | 5 h |
| 2749 | | | | | | |
| ST 61 | | | | 10 min | 3 h | 7 h |
| LV | | | | | | |
| SEAL | | | no cure | tacky | | 24 h* |
| 100 | | | after 1 week | after 24 h | | |

*still some surface tackiness

TABLE 3
Drying state after 24 hours with gamma aminosilane
or amino aminosilane as curing agent

| | Gamma amino silane | | | Alpha amino silane | | |
|---|---|---|---|---|---|---|
| Polymer | 3 wt % | 5 wt % | 10 wt % | 1 wt % | 5 wt % | 10 wt % |
| S XP 2749 | tacky | touch dry^{a} | hard dry^{b} | hard dry | hard dry | hard dry |

^{a}tacky underneath;
^{b}wrinkled surface

### Example 2—Foul Release Performance

The foul release properties of different coatings were determined in a so-called slime farm test. Different coatings were applied on glass microscope slides. The coated slides were immersed in seawater for 2 weeks to remove any residual solvent. The coated slides were then placed in the recirculation reactor of a multispecies slime culturing system. This is a recirculating artificial seawater system (temperature 22±2° C., salinity 33±1 psu (practical salinity units), pH 8.2±0.2) inoculated with a multispecies culture of wild microorganisms. The system mimics a semi-tropical environment whereby, under controlled hydrodynamic and environmental conditions, marine biofilms are cultivated and subsequently grown on coated test surfaces under accelerated conditions. After 14 days, the samples were removed and tested for biofilm release in a variable-speed hydrodynamic flow-cell. The fouled microscope slides were mounted in the flow cell, and fully turbulent seawater was passed across the surfaces. The water velocity was increased incrementally from zero to 820 liters/hour, and was remained constant at each speed for 1 minute. Before each speed increment the slides were imaged and the amount of biofilm retained on the surface as a percentage of the total area (% cover) was assessed using image analysis software (ImageJ, version 1.46r, Schneider et al. 2012). The percent cover of biofilm was averaged across 6 replicate slides, and mean percent cover was compared between surfaces at each speed.

The slime farm fouling settlement and release was determined for a comparison composition with hydroxyl-terminated polydimethylsiloxane as the only curable polymer, tetraethylorthosilicate (TEOS) as curing agent, and dioctyltindilaurate as curing catalyst and compositions illustrative for coating compositions herein with curable polymer (i) with terminal alkoxysilyl groups as the only binder polymer, TEOS as curing agent and a curing catalyst. In Table 4, the composition of the coating compositions applied is given. The results for specific alkoxysilyl terminated polymers are shown in Table 5.

TABLE 4
Coating compositions used in slime
farm test (all components in wt %)

| | comparison | embodiment |
|---|---|---|
| OH-terminated PDMS | 70.9 | — |
| Alkoxysilyl terminated polymer | — | 94.5 |
| Solvent (Xylene) | 20.7 | — |
| Curing agent (tetraethylorthosilicate) | 3.2 | 5.0 |
| Pot life extender (2,4 pentadione) | 4.6 | — |
| Catalyst (dioctyltindilaurate) | 0.6 | — |
| Catalyst (K-KAT ® 670) | — | 0.5 |

TABLE 5
Percentage slime coverage for different coatings (slime farm test)

Flow rate (liters/hour)

| | 270 | 550 | 820 |
|---|---|---|---|
| OH-terminated PDMS (comparison) | 100 | 100 | 95 |
| STP-10 (embodiment) | 80 | 40 | 30 |
| STP-30 (embodiment) | 96 | 82 | 60 |
| STP-15 (embodiment) | 94 | 88 | 82 |
| STP-35 (embodiment) | 98 | 98 | 95 |
| S XP 2749 (embodiment) | 84 | 74 | 68 |

### Example 3—Foul Release Performance—Biofouling Test

Marine grade plywood test panels were primed with an epoxy/amine-based primer to give an average dry film thickness of about 100 μm. A tie-coat based on a polyacrylate with alkoxysilyl pendant groups (acrylic tie-coat composition 1, prepared as described in Example 4) was then applied to give an average dry film thickness of about 100 μm and the tie-coat was allowed to dry. A foul release topcoat composition was then applied to the pre-treated panels in an average dry film thickness of about 150 μm.

Several topcoat compositions, each with an alkoxysilyl terminated polymer (i), a catalyst, optional curing agent (tetraethylorthosilicate), and a hydrophilic-modified polysiloxane oil were applied. As a comparison, equivalent topcoat compositions without hydrophilic-modified polysiloxane oil (incompatible fluid) were applied (comparison 1). As a further comparison, a topcoat comprising a hydroxyl-terminated polydimethylsiloxane as the curable polymer and a hydrophilic-modified polysiloxane oil was applied (comparison 2). In Table 6, the compositions of the foul release topcoat compositions are given.

TABLE 6
Coating compositions used in biofouling (all components in wt %)

| | embodiment | embodiment | compar- | compar- |
|---|---|---|---|---|
| | (no curing | (with curing | ison 1 | ison 2 |
| | agent) | agent | (no fluid) | (PDMS) |
| OH-terminated PDMS | — | | | 70.6 |
| Alkoxysilyl terminated | 74.6 | 69.6 | 79.6 | — |
| polymer | | | | |
| Solvent (naphtha) | 19.9 | 19.9 | 19.9 | 20 |
| Solvent (xylene) | | | | |
| Curing agent | | 5 | | 3.7 |
| (tetraethylorthosilicate) | | | | |
| Catalyst | 0.5 | 0.5 | 0.5 | 0.7 |
| Poly(oxyethylene) | 5 | 5 | | 5 |
| modified polysiloxane | | | | |
| oil* | | | | |

*DC-57

The panels were then immersed in Singapore, at Changi Marina, an aquatic environment where heavy marine fouling growth is known to occur. After 1 month immersion an assessment was made of the board to quantify severity of biofouling that was present. The results (% biofouling coverage) are shown in Table 7. The panels with a topcoat with OH-terminated PDMS and poly(oxyethylene) modified polysiloxane oil (comparison 2) showed a biofouling coverage comparable with the coverage on the panels with topcoats with alkoxysilyl-terminated curable polymer and poly(oxyethylene) modified polysiloxane oil.

TABLE 7
Biofouling coverage (%) in board test

| Test | curable | | curing | biofouling coverage (%) | |
|---|---|---|---|---|---|
| no. | polymer | catalyst | agent | fluid DC-57 | no fluid |
| 1 | STP-15 | DBU* | No | 12 | 81 |
| 2 | STP-E15 | zinc** | yes | 15 | 80 |
| 3 | STP-E30 | zinc** | | <1 | 98 |
| 4 | STP-E10/XP 2749 | zinc** | | 3 | 99 |
| | (50/50) | | | | |
| 5 | STP-E35 | Zinc** | yes | 7 | 98 |
| 6 | STP-E35 | DBU* | | 28 | 99 |
| 7 | XP 2749 | DBU* | | 19 | 100 |

*DBU: 1,8-diazabicyclo(5.4.0)undec-7-ene
**K-KAT ® 670
*** dioctyltindilaurate

### Example 4—Adhesion to Different Primers/Tie-Coats

For different coating compositions according to the embodiments herein, adhesion to different primers/tie-coats was determined.

### Preparation of Acrylic Tie-Coat Composition 1

A siloxane functional polyacrylate was prepared by copolymerizing a mixture of methyl methacrylate, lauryl methacrylate and trimethoxysilylpropyl methacrylate in the presence of mercaptopropyl trimethoxysilane as chain transfer agent and 2,2′azobis(2-methylbutyronitrile (AMBN) as initiator in methyl n-amyl ketone (MAK) as solvent at 100° C. The methyl methacrylate/lauryl methacrylate/trimethoxysilylpropyl methacrylate/mercaptopropyltrimethoxy silane molar ratio was 70/12/15/3. A solution of 70 wt % polymer in MAK was obtained.

### Preparation of Acrylic Tie-Coat Composition 2

A siloxane functional polyacrylate was prepared as described above for acrylic tie-coat composition 1, but with trimethoxysilylmethyl methacrylate instead of trimethoxysilylpropyl methacrylate.

Commercially available primers/tie-coats used

Intershield 300 (ex. AkzoNobel): epoxy-based primer

Intergard 263 (ex. AkzoNobel): epoxy-based primer/tie-coat

Intertuf 203 (ex. AkzoNobel): vinyl-based primer

Interprotect (ex. AkzoNobel): epoxy-amine based primer

Primocon (ex. AkzoNobel): vinyl-based primer

### Coating Compositions

Five coating illustrative coating compositions (coatings 1 to 3, 5 and 7) and two illustrative coating compositions (coatings 4 and 6) were prepared, each with a composition as shown in Table 8.

TABLE 8
Foul release topcoats for adhesion test (all components in wt %)

| | 1 | 2 | 3 | 4 | 5 | 6 | 7 |
|---|---|---|---|---|---|---|---|
| STP-E10 | 85 | 89.5 | | | 40.5 | | 27 |
| STP E15 | | | | 37.5 | | 25 | |
| STP-E35 | | | 69.5 | | | | |
| Polyacrylate with | | | | 25 | 27 | 37.5 | 40.5 |
| alkoxysilyl groups* | | | | | | | |
| Adhesion promoter | 1.5 | | | | | | |
| Curing agent | | | | 1.5 | 1.5 | 1.5 | 1.5 |
| (tetraethylorthosilicate) | | | | | | | |
| Zinc catalyst** | 2 | 0.5 | 0.5 | 1 | 1 | 1 | 1 |
| Solvent (xylene) | 10 | 10 | 30 | | | | |
| Solvent (1-methoxy-2- | | | | 30 | 30 | 30 | 30 |
| propanol) | | | | | | | |
| Poly(oxyethylene) | | | | 5 | | 5 | |
| modified polysiloxane | | | | | | | |
| oil** | | | | | | | |
| Adhesion promoter | 1.5 | | | | | | |
| (chlorinated | | | | | | | |
| polyolefin) | | | | | | | |

*Same polymer as in acrylic tie-coat composition 1
**(K-KAT ® 670)
*** DC-57 (ex. DOW)

### Adhesion Test

A layer of a primer or tie-coat composition was applied directly to an uncoated glass panel. The applied layer was allowed to dry and a second layer of a foul release coating composition was applied. Adhesion between the first coat (primer or tie-coat) and the second coat (foul release coat) was determined using a penknife adhesion test. In this test, a penknife is used to cut a V-Shape into both coating layers; the level of adhesion is then assessed by inserting the point of the penknife blade under the coating at the vertex of the ‘V’, noting how difficult, or easy, it is to separate the second coating from the first coating.

TABLE 9
results of adhesion test

| | Foul release topcoat | | | | | | |
|---|---|---|---|---|---|---|---|
| Primer | 1 | 2 | 3 | 4 | 5 | 6 | 7 |
| Acrylic tie-coat | Very | Very | Very | | | | |
| composition 1* | good | good | good | | | | |
| Acrylic tie-coat | Very | Very | Very | Very | Very | Very | Very |
| composition 2* | good | good | good | good | good | good | good |
| Intershield 300 | Poor | | | | | | |
| Intergard 263 | Poor | | | | | | |
| Intertuf 203 | | | Poor | | | | |
| Interprotect | | | | weak | weak | passable | passable |
| Primocon | | | | weak | weak | passable | passable |

*applied as 70 wt % polymer in MAK

### Example 5—Contamination

The impact of contamination of a surface with curable resin system on the aesthetic appearance of a subsequently applied polyurethane finish coat was determined as follows.

To an aluminum test panel primed with an epoxy-based primer, a diluted solution of a curable resin system (1 wt % in xylene) was applied using a 50 μm draw down bar. The resin was allowed to dry for 4 hours at ambient conditions.

Using a draw down bar, a polyurethane finish coating composition was applied on the dried coating in a wet thickness of 150 μm. The polyurethane coating composition was allowed to dry and the appearance of the polyurethane finish coat was determined. The appearance of the polyurethane finish coat was categorized as follows:
1. Coating 100% unaffected
2. 1%-20% of surface area exhibiting surface defects
3. 21%-50% of surface area exhibiting surface defects
4. Greater than 50% of surface area exhibiting surface defects

Surface defects may be in the form of pinholes, fish eyes, poor surface wetting or any other undesired surface characteristics.

The results are shown in Table 10.

TABLE 10
Contamination test

| | Appearance |
|---|---|
| Contaminating curable resin system | polyurethane coat |
| 100 wt % moisture curable PDMS | 4 |
| 99.5 wt % STP-35 + 0.5 wt % zinc catalyst | 1 |
| 98.5 wt % STP-35 + 1 wt % PDMS + 0.5 wt % | 2 |
| zinc catalyst | |
| 94.5 wt % STP-35 + 5 wt % PDMS + 0.5 wt % | 4 |
| zinc catalyst | |
| 89.5 wt % STP-35 + 10 wt % PDMS + 0.5 wt % | 4 |
| zinc catalyst | |

1. A non-aqueous liquid foul release coating composition for controlling aqueous biofouling on man-made objects, comprising:
(A) a curable resin system comprising
i) a curable polymer free of fluorine atoms and having a backbone selected from a polyurethane, a polyether, a polyester, a polycarbonate or a hybrid of two or more thereof, and having at least one terminal or pendant alkoxysilyl group of formula
—(CₘH₂ₘ)—Si(R¹)₍₃₋ₙ₎(OR²)ₙ (I)
wherein:
n is 1, 2 or 3;
each of R¹ and R² is, independently, an alkyl radical having 1 to 6 carbon atoms,
m is an integer with a value in the range of from 1 to 20, and
ii) optionally a curing agent and/or a catalyst; and
(B) a marine biocide and/or a non-curable, non-volatile compound selected from the group consisting of fluorinated polymers, sterols and sterol derivatives, and hydrophilic-modified polysiloxane oils,
wherein the coating composition is essentially free of a curable polysiloxane, and
wherein the coating composition is essentially free of non-curable polysiloxanes other than non-curable hydrophilic-modified polysiloxane oils.

2. The foul release coating composition of claim 1, wherein curable polymer (i) has at least one alkoxysilyl terminal group of formula (I).

3. The foul release coating composition of claim 1, wherein the at least one terminal or pendant alkoxysilyl group is attached to the backbone of the curable polymer (i) via a urethane or a urea linkage.

4. The foul release coating composition of claim 1, wherein m is 1 or 3, preferably 1.

5. The foul release coating composition of claim 1, wherein R² is a methyl or ethyl radical.

6. The foul release coating composition of claim 1, wherein the curable resin system comprises a curing agent selected from the group consisting of tetra-alkoxyorthosilicates and partial condensates thereof, organofunctional alkoxysilanes, and combinations thereof, preferably the curing agent is a tetra alkoxyorthosilicate or a partial condensate thereof, and alkoxysilanes with an isocyanurate functional group, or a combination thereof.

7. The foul release coating composition of claim 6, wherein the curing agent is an organofunctional alkoxysilane with the alkoxysilyl functionality in an alpha position to the organofunctional group.

8. The foul release coating composition claim 1, wherein the coating composition is free of a marine biocide.

9. The foul release coating composition claim 1, wherein the coating composition comprises a non-curable, non-volatile compound selected from the group consisting of hydrophilic-modified polysiloxane oils.

10. The foul release coating composition of claim 9, wherein the non-curable, non-volatile hydrophilic-modified polysiloxane oil is a poly(oxyalkylene)-modified polysiloxane.

11. A substrate coated with a foul release coating composition of claim 1.

12. The substrate of claim 11, wherein the substrate is coated with a multi-layer coating system comprising:
optionally a primer layer applied to the substrate and deposited from a primer coating composition;
a tie-coat layer applied to the substrate or to the optional primer layer, deposited from a tie-coat composition comprising a binder polymer with curable alkoxysilyl functional groups; and
a topcoat layer applied to the tie-coat layer, the topcoat layer deposited from a liquid foul release coating composition claim 1.

13. The substrate of claim 11, wherein the tie-coat composition comprises a polyacrylate with curable alkoxysilyl functional groups.

14. A process for controlling aquatic biofouling on a surface of a man-made object, comprising the steps of
(a) applying a foul release coating composition to at least a part of the surface of the man-made object;
(b) allowing the foul release coating composition to cure to form a cured foul release coating layer; and
(c) immersing the man-made object at least partly in water.

15. The process of claim 14, further comprising the step of applying a tie-coat layer deposited from a tie-coat composition on the at least part of the surface of the man-made object before applying the foul release coating composition.

16. (canceled)

17. The foul release coating composition of claim 6, wherein the curing agent is a tetra-alkoxyorthosilicate or a partial condensate thereof.

18. The foul release coating composition of claim 6, wherein the organofunctional alkoxysilane is selected from the group consisting of amino alkoxysilanes, glycidoxy alkoxysilanes, methacryloxy alkoxysilanes, and carbamato alkoxysilanes.

19. The foul release coating composition of claim 7, wherein the curing agent is (N,N-diethylaminomethyl)triethoxysilane and the coating composition is essentially free of a curing catalyst.
